(19) United States
(12) Patent Application Publication
(10) Pub. No.: US 2010/0290840 A1
(43) Pub. Date: Nov. 18, 2010

(54) PLASTIC ROCK-BOLT OR DOWEL AND METHOD OF MANUFACTURING OF THE SAME

(76) Inventors: Phillip Hanford Boot, New South Wales (AU); Denise Boot, New South Wales (AU)

Correspondence Address: MICHAEL J. STRIKER, 103 EAST NECK ROAD, HUNTINGTON, NY, 11743, US

(21) Appl. No.: 12/596,270

(22) PCT Filed: Apr. 15, 2008
(86) PCT No.: PCT/AU08/00530

§ 371 Date: Feb. 24, 2010

(30) Foreign Application Priority Data
Apr. 17, 2007 (AU) 2007902023

(51) Int. Cl. E21D 21/00; B29C 47/02

(52) U.S. Cl. 405/259.1; 264/129

(57) ABSTRACT

A fibre reinforced rock dowel (10) for use in reinforcing strata or the like has a generally cylindrical shank (12) having a longitudinal axis and defines one or more groups of mixing vanes (16, 18, 20) projecting from the shank, and a threaded end (14) for the attachment of a nut (13). The dowel is reinforced by inner (21a) and outer (21b) filaments extending generally along the longitudinal axis. At least the outer filaments extend in a generally helical path through the dowel with outer filaments extending in a helical path in the opposite sense to the thread of the threaded end. The dowel is manufactured by a process in which continuous fibre filaments (7) are drawn through a resin filled bath (6) into a press (4) with fixed lower and movable upper heated dies so that when the press closes it moulds the shape of the dowel, in a process known as pulforming”, with the cured dowel attached to the filaments being rotated about its longitudinal axis to impart twist to the fibres in the dies (4a, 4b).

### FIELD OF THE INVENTION

The present invention relates to a plastic rock-bolt or rock-dowel for use in the reinforcement of earth strata, such as in underground mining and tunnelling in coal mines.

### BACKGROUND OF THE INVENTION

Rock-bolts are used in mining, tunnelling, and in general stabilisation. One use of rock-bolts is in the coal mining industry where underground roadways or tunnels are excavated to facilitate the main mining operation. The tunnels have to be reinforced for safety reasons. Traditionally this has been done with steel rods called rock-bolts or rock-dowels. Such reinforcement may be of a permanent or temporary nature. Where the reinforcement is of a temporary nature, the reinforced strata may be subsequently excavated/mined.

However, when a steel rock-bolt is used to reinforce this part of the strata, expensive damage can occur to the excavating equipment used in the later excavation, and also to equipment used in convoying the excavated material.

Because of this problem with steel rock-bolts, fibre reinforced composite (FRP) rock-bolts have become popular, particularly for temporary applications. Such materials have lower shear strength characteristics than steel and will not tend to damage the excavating or conveying equipment. FRP rock-bolts are also used in other applications such as “soil nailing” where the bolts, when used for temporary purposes, can be easily broken or cut up and removed at a later date when or if required.

In coal mining, the use of fibre reinforced dowels or bolts is limited to the mining or “later to be excavated” side of the access tunnel walls (called ribs) or what is commonly called the “cuttable” side. Steel rock-dowels are usually used in the other non “cuttable” side and the roof of the access tunnel,

A typical rock bolt or dowel used in coal mines is usually a rod of 20 mm-22 mm diameter and varying length from 900 mm-1800 mm, which is inserted in a pre-drilled hole of approximately 28 mm diameter and encapsulated in a binding cementicious material, usually a two part resin material.

In many cases, the rod has a threaded end that projects out of the hole where a washer and nut are attached to the rod. After encapsulation, the nut is tightened down to exert a pressure on the strata surface.

The sequence of dowel installation is, firstly a hole is drilled in the strata to the required depth, the drill bit is then removed from the drill chuck and replaced by a socket spanner. A two part resin binding agent contained in a flexible capsule of varying length is inserted into the hole. The capsule keeps the two components separate. Then the dowel, including a plate and a nut partially screwed onto the threaded end is partly inserted into the hole.

The nut is engaged by the thin chuck and spun vigorously whilst being pushed further into the hole, thus breaking the capsule and mixing the two resins together. The nut has a cap which prevents it from being screwed further down the dowel thread during the spinning operation. The dowel is then held motionless for a number of seconds whilst the, now mixed, resin solidifies.

When the resin is hardened, the nut is turned further down on the now rigidly held encapsulated dowel which breaks out a cap on the end of the dowel at a pre-determined torque value and allows the nut to be tightened, creating force on the washer plate and strata surface until the desired torque value is attained. This value is determined by the skill of the drill rig operator.

The torque value is usually accomplished by guesswork which can be quite difficult as working conditions are usually tricky. Mines tend to be poorly lit, and the installation equipment is robust and very strong. Typically, the equipment operator cannot see if he has damaged the dowel by over-tightening of the nut, nor can he tell if the encapsulation is adequate or successful.

In many cases, the machines that excavate the access tunnel also install the reinforcement dowels at the same time. These machines have drilling rigs positioned on the machine, and the sides and the roof of the tunnel are reinforced with dowels as the tunnel forming machine advances.

The drilling rigs are operated hydraulically and are basically designed to install steel rock-dowels. Thus, when installing the FRP dowels on the “cuttable” side, a problem arises due to the high torque performance of the drill rig required for the steel dowels and the low torque values of the FRP dowels.

The strength of the installation drill rig and the significant difference in shear and torque values between steel and FRP dowels, results in the FRP dowel being easily damaged unless the operator is experienced, skilled and very careful. In extreme cases the head of the dowel is twisted off.

Some mines have “automatic bolters” mounted on the tunnelling machine, which cannot be used effectively with FRP dowels because of the difference in torque values between steel and FRP dowels.

Because the FRP dowel is not visible to the operator, it can be damaged without the operator's knowledge. In the past, damaged FRP dowels have caused walls to collapse resulting in severe injuries to mining personnel. These incidents have prompted officially written safety warnings by State mining authorities concerning the use of fibreglass or composite dowels.

To overcome this problem some FRP dowel manufacturers have developed what is known as a “thrust” dowel. This type of dowel has an enlarged nut shaped head but has no thread to exert force onto the strata surface. The installation drill rig simply pushes the head of the dowel hard into the hole until the encapsulating binder solidifies.

However, when using a thrust dowel, the operator cannot tell if there is sufficient load onto the strata or, more importantly, if the encapsulation has worked satisfactorily, which is critical for the safety of mining personnel. Hence there are also safety issues with the use of thrust dowels.

The performance of thrust dowels is significantly inferior to a threaded dowel in that the force applied to the strata surface is less than one third of that of the threaded dowel.

The failure of mining personnel to be aware of the above potential causes of failure during and after dowel installation, means that the strata may not be adequately reinforced. This is potentially dangerous and is a known health hazard.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

In a first broad aspect, the present invention provides a fibre reinforced rock dowel for use in reinforcing strata or the like having a generally cylindrical shank having a longitudinal axis, the dowel defining a threaded end for the attachment of a nut having a left or right hand thread thereto wherein the dowel is reinforced by at least inner and outer filaments extending generally along the longitudinal axis and wherein at least the outer filaments extend in a generally helical path through the dowel with outer filaments.

The outermost or overlay filaments/fibres will be longer than the innermost filaments. Both inner and outer filaments will typically be continuous (i.e. unbroken) through the length of the dowel.

It is preferred, but not essential, that the complete rock dowel be manufactured from reinforced plastic in one single moulding operation, and that the plastic is a thermoset and the reinforcing is a continuous glass fibre. The fibres could however be made of any suitable fibre or filament such as steel or any mixture of fibres/filaments.

The method of manufacture of the dowel is that, continuous fibre filaments are drawn through a resin filled bath into a press with fixed upper and lower heated dies so that when the press closes it moulds the shape of the dowel, in a process known as “pulforming”.

Typically, one or more mixing vanes will project from the shank. The rock-dowel reinforcing system can also be provided with a specially manufactured glass reinforced plastic (FRP) nut that in part shears off when a certain torque value is reached, this value is less than the torque value of the FRP dowel, thus preventing damage to the dowel during the installation procedure as described in Patent No. 2006100511.

Because of difficult conditions with underground installation the torque value required for the shear nut to operate efficiently is above 110 ft/lbs, the ultimate torque value of the dowel, for example, for a 20 mm diameter fibreglass dowel the torque value is approximately 85 ft/lbs-110 ft/lbs. Although a 22 mm diameter dowel has a higher torque value in most cases these dowels can jam in the pre-drilled hole during installation if these dowels have mixing vanes.

The torque value of the dowel is governed by the bond strength between the thermoset resin and the continuous fibre reinforcing and as the fibres are aligned in the same plane as the dowel, the torque stresses can split a 20 mm diameter dowel relatively easily at approximately 110 ft/lbs.

This torque value for the dowel is too low to cope with the variations in conditions that occur underground even when using a torque shear nut.

To overcome this problem and make the torque value of the dowel much higher, the reinforcing fibre in the dowel is used to strengthen the dowel to resist the torque forces.

Typically, the overlaying of the outer fibres at an angle over the inner fibres so as to resist the forces is accomplished during the manufacture of the dowel by use of a rotating device activated prior to the dowel being moulded in between the heated dies.

Thus in a related aspect the present invention provides a method of manufacturing a fibre-reinforced rock dowel for use in reinforcing strata or the like, the dowel having a generally cylindrical shank defining a longitudinal axis, the dowel further defining a threaded end for the attachment of a nut comprising the steps of:

drawing a plurality of longitudinally extending resin coated reinforcing filaments including inner and outer filaments into an open mould;

rotating the filaments so that at least the outer filaments are oriented in a generally helical path;

closing the mould to form the dowel wherein the dowel is reinforced by inner and outer filaments extending generally along the longitudinal axis wherein at least the outer filaments extend in a generally helical path through the dowel.

Of particular importance is that the direction of the overlaying fibres must be in the same direction as the tightening of the nut during installation so that the overlaying fibres are in greater tension when the force is applied, for example with a right handed threaded bolt and nut the direction of overlay must be diagonal right to left from the dowel head to the tip or in the same direction as a left hand thread (left handed helical path) so that the overlaid fibres are in a direct tensile direction to resist the torsional forces.

The ultimate tensile strength of the dowel is determined by the number of fibre filaments, when the fibres are rotated above certain levels the torsion value increases but another effect is a reduction in the tensile strength of the dowel.

In designing a dowel a compromise between tensile strength and torque strength must be made to suit the application and uses.

The ideal number of complete rotations for a 20 mm diameter dowel is approximately 3 to 4 per metre length, below this number the overlay angle is insufficient to affect the torque significantly, the maximum is approximately 8 rotations per metre length. A lesser minimum number of turns, say 3,may provide some improvement.

Between this range of rotations the torque value of the dowel can be increased by double to treble the value over a dowel having straight fibre filaments

The angle and depth of the overlaying fibres in relation to the tensile forces being applied are significant to the un-encapsulated length of the dowel. For example, at 4 turns per metre the extreme outer layers are at an angle of approximately 10 degrees to the longitudinal axis of the dowel, theoretically, as the layers progress to the centre of the dowel the angles of the fibres/filaments to the longitudinal axis diminish to approximately zero at the dead centre.

The very extreme outer layers may not be enough to resist the torsional forces so there will be an optimum average of angle related to the depth of overlaying fibres, dowel length and the degree of torsional force applied. In this case the extreme outer layers may have to be overlaid at a greater angle than the optimum theoretical angle required. The situation may be complicated by the elasticity or ductility of the resin binder used to manufacture the dowel and the length of un-encapsulated dowel, for example, if that un-encapsulated length was 200 mm the optimum angle may be different to an un-encapsulated length of 600 mm.

The diameter of the dowel also plays a significant role in arresting the torsional forces as these forces are higher at the circumference than any other part of the section of the dowel, also the overlaying outer fibres are by necessity longer than the inner straighter fibres with a subsequent small increase in fibre content of the dowel.

Another feature of this manufacturing method is that prior to moulding the rotational movement causes the resin trapped in the central core of the bundle of fibres to migrate to the outside of the unmoulded bundle of fibre rovings. This effect assists with the pressing process and forms the thread and deformations on the surface of the dowel more easily.

The effect of the resin migrating to the outside of the fibre bundle improves the product and reverses the effect of the nozzle which the bundle of rovings is pulled through to exclude the excess resin as the fibre move through the resin bath.

### BRIEF DESCRIPTION OF THE DRAWINGS

A specific embodiment of the invention will now be described, by way of example only, and with reference to the accompanying drawings, in which:

FIG. 1 is a drawing of a rock dowel, nut and washer plate;

FIG. 1a is a front view of part of the rock dowel of FIG. 1;

FIG. 1b is side view of side A of the rock dowel shown in FIG. 1a

FIG. 1c is side view of side B of the rock dowel shown in FIG. 1a

FIG. 2 shows a part section through the nut shown in FIG. 1;

FIG. 3 is a side elevation of a first part of a machine for making the rock dowel of FIG. 1; and

FIG. 4 is an isometric view of the rotating and clamping system of the machine whose first part is shown in FIG. 3.

### DETAILED DESCRIPTION OF A PREFERRED EMBODIMENT

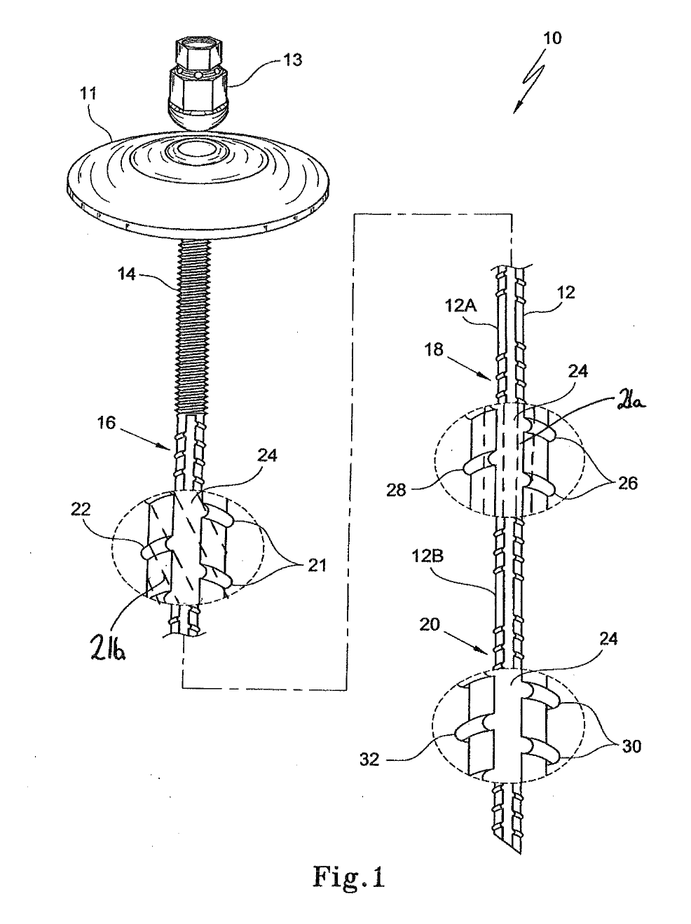

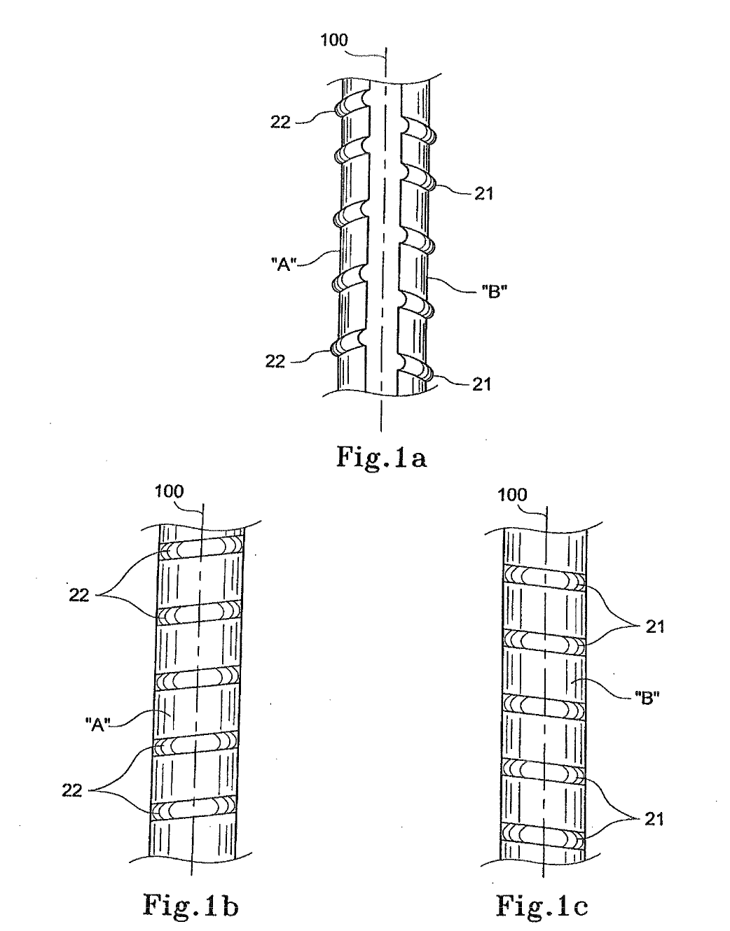

FIG. 1 shows a typical rock dowel 10 formed by a pulforming method in one three dimensional single manufacturing operation. The dowel has a shank 12. FIG. 1 also shows a washer plate 11 and a nut 13. One end 14 of the shank is threaded. Three groups 16, 18 and 20 of projecting mixing vanes are spaced along the shank 12 of the dowel.

Shown as dashed lines, are inner fibres/filaments 21a and outer fibres/filaments 21b. As shown the outer fibres 21b overlay the inner fibres at an angle. Both inner and outer fibres are substantially continuous filaments, i.e. are unbroken and extend from one end of the dowel to the other. The outer filaments follow a generally helical path in the opposite sense to that of the threaded portion 14. As shown the threaded portion has a right hand thread, so the filaments extend along an opposite left hand helix.

The vanes 20, 22 of the first group 16 of projecting mixing vanes adjacent the threaded portion 14, project approximately 0.5 mm-1 mm out from the dowel shank 12, most preferably about 1 mm. Vanes 20, 22 extend out from opposed sides of the dowel shank separated by diametrically opposed flattened portions 24 of the shank, of which only one is shown. The vanes 20 extending from one side of the shank are offset from those 22 extending from the opposite side of the shank.

With reference to FIGS. 1a to 1c, it can be seen that the mixing vanes 22 on one side or face “A” of the shank are not perpendicular to the longitudinal axis but rather are part-helica/spiral having a left hand thread such that as the shank is rotated in a clockwise sense about its longitudinal axis, the vanes 22 tends to push material towards the head of the shank, The mixing vanes 20 on the opposite face 13 of the shank are also part-helical/spiral but have a right hand thread such that as the shank is rotated in a clockwise sense about its longitudinal axis, the vanes 20 tend to push material towards the tip of the shank. Thus in use, as is described below, the vanes counteract each other.

There are approximately ten vanes extending from either side of the shaft in the first group 16, however the specific number of vanes is not critical and may be varied.

There is a gap 12a on the shank where there are no vanes followed by the second group of vanes 18. The configuration of the second group is largely the same as that of the first group, with vanes 26 and 28 being offset relative to one another and separated by opposed flattened portions 24. The length of the gap 12a is not critical. The size of the vanes 26, 28 is greater than those of the first group, projecting from about 1.5 to 2 mm from the shank. While there are approximately ten vanes extending from either side of the shaft in the second group, the specific number of vanes is not critical and may be varied. There is a gap 12b on the shank where there are no vanes followed by the third and final group of vanes 20 located at the distal or tip end of the shank. The configuration of the third group is largely the same as that of the first and second groups, with vanes 30 and 32 being offset relative to one another and separated by a flattened portions 24. The length of the gap 12b is again, not critical. The size of the vanes 30, 32 is greater than those of the second group, projecting from about 2.5 to 3 mm from the shank. The number of vanes in the third group should preferably be limited to between two and eight vanes on each side of the shank.

In all the groups 16, 18 and 20, the spacing between the vanes in each section can vary between 10 mm-30 mm, but is preferably about 20 mm.

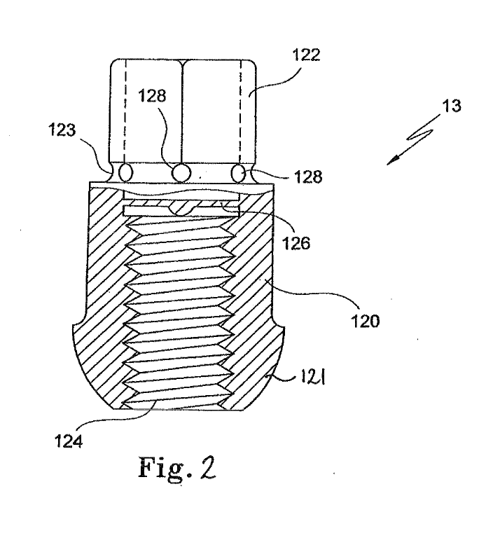

FIG. 2 shows the nut 4 in more detail. It includes a circular generally annular barrel section 120 having a truncated hemi-spherical end portion 121 connected to a co-axial hollow hexagonal section 122 by a recessed annular weakened portion 123. The hollow hexagonal section 122 may or may not be internally threaded. The barrel section 120 has an internal thread 124. A breakout cap 126 that allows the dowel 2 to be spun during the spinning and mixing stage separates the interior of the barrel section 120 from the hexagonal section 122. This cap 126 will break out at a set torque level significantly less than the torque level required to shear the weakened portion 123 and separate the hexagon 122 and barrel 120. Also shown are apertures 128 in the weakened portion 123 and recesses 130 (refer to FIG. 7) which combine to allow the hexagon section 122 to separate from the barrel section 120 at the required torque value.

The position of the breakout cap 126 is close to the junction 123 of the hexagon section 122 and the barrel section 120. This is preferable in that when these two sections part and the nut 4 is in the final position, the amount of projection of the threaded end 2b of the dowel will be as small as possible.

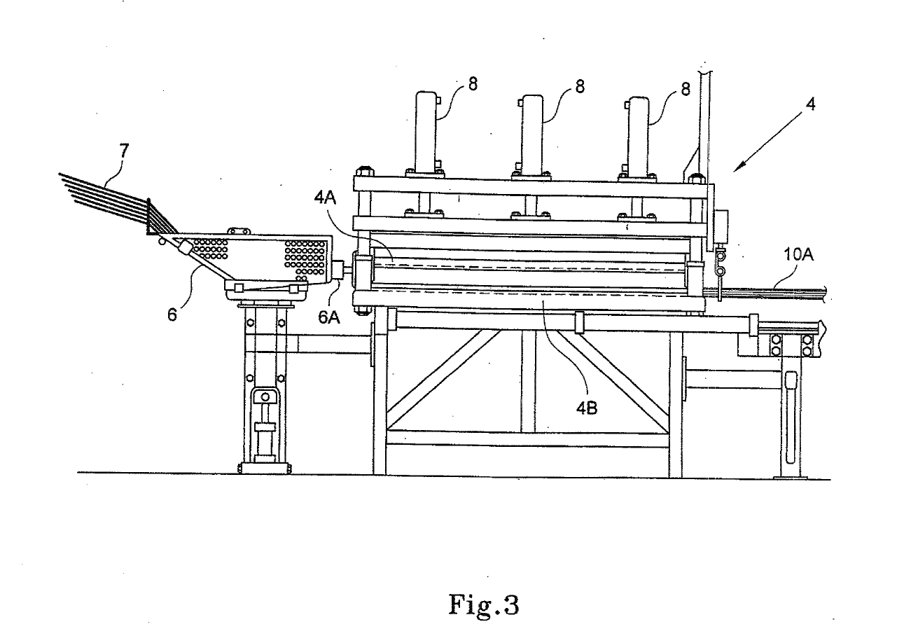

FIG. 3 shows a pulforming press 4 used to make the rock dowel 10. On the left hand side of the Figure, a plurality of generally parallel continuous fibre filament rovings 7 are drawn into and through a resin filled bath 6. While in the bath the fibres are maintained in a spaced apart relationship by means of a perforated plate defining an array of holes through which the fibres pass and which maintains the filaments in a generally parallel spaced apart relationship. The fibre filaments 7 are drawn/pass out of the bath 6 through a nozzle 6a which removes excess resin from the filaments 7.

Next, the fibre filaments pass into a press 4. The press has a movable heated upper die 4a and a fixed lower heated die 4b. The press 4 is closed by hydraulic means 8 and the dowel 10 is formed between the upper and lower heated dies 4a and 4b. The dies define the shape of the exterior of the rock dowel in particular the threaded end 14 and groups of vanes 16, 18 and 20.

Before the press is closed, the plurality of filaments 7 are rotated by means of a rotating and clamping system which is described in more detail below. This causes the outer fibres to twist and to tend to overlay the innermost fibres. During the rotating process the outer fibres become more taught and draw more fibre 7 into the press 4. The innermost fibres, being in the centre of the dowel, do not lengthen and overlay. The length of the dies 4a and 4b is approximately equal to the length of the rock dowel 10a.

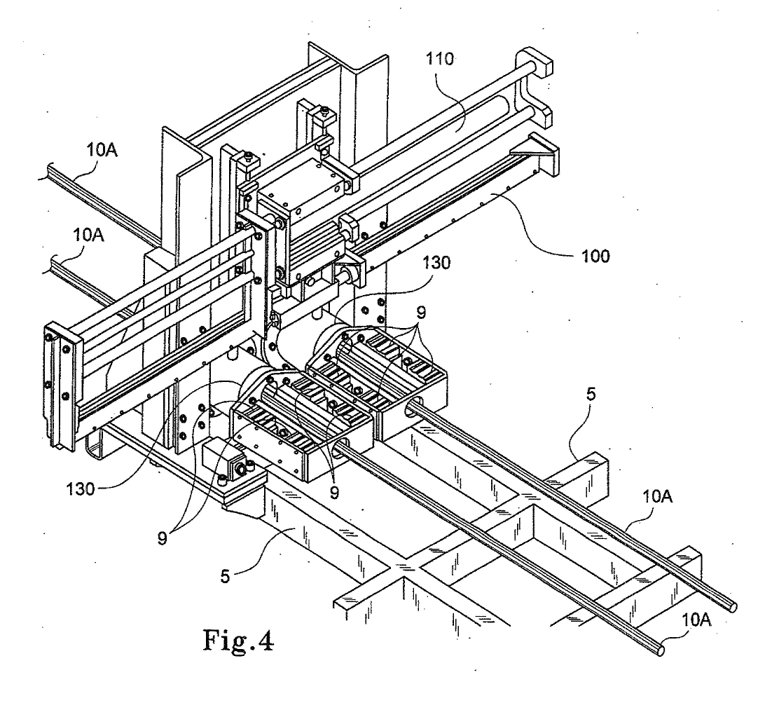

When the resin is cured, the press 4 is opened and the cured rock dowel 10a is clamped and drawn out of the press 4 by clamping means 9 (refer to FIG. 4) positioned on a moveable carriage 5. This automatically draws new lengths of resin saturated fibres 7 which are still connected to the fibres in the cured dowel 10, into the press 4. The carriage clamping system 9 releases the cured dowel 12 and then returns back to the press 4.

FIG. 4 shows a rotating and clamping system mounted on the moveable carriage 5 where the formed and cured dowels 10a are clamped by means of air operated cylinders 9. The rotating system rotates the cured dowel 10a a number of times as the carriage moves away from the press. The cured dowel is still attached to the fibres/filaments 7 so that rotation of the cured dowel effects rotation of the filaments currently in the mould 4. The rotating mechanism includes a toothed rack 100, a pinion (not shown) and a cylinder 110 which when pressurised moves the rack 100 sideways and rotates the clamps. The air pressure to activate the clamps is constantly supplied through an inner and outer air ring valve 130.

The number of rotations can be varied to suit different applications. For example, an end anchored type bolt or dowel which incorporates an. expansion shell to anchor the tip or end of the dowel in the hole will require more rotations than an encapsulated dowel.

Clearly other mechanisms for rotating the cured dowel/filaments could be used.

A saw (not shown) mounted on the carriage 5 then cuts the dowel 10a to the desired length after the clamping station.

Although the specification describes the use of fibre glass rovings forming the filaments it will be appreciated that other fibres may be used to form the filaments such as steel wire. In one embodiment, the filaments may comprise bundles of very thin steel wires. However, fibre glass is preferred, particularly for cost reasons. As used herein the term filament includes filaments comprising a bundle of fibres/filaments and well as filaments comprising a monofilament such as a single wire.

It will be appreciated by persons skilled in the art that numerous variations and/or modifications may be made to the invention as shown in the specific embodiments without departing from the spirit or scope of the invention as broadly described. The present embodiments are, therefore, to be considered in all aspects as illustrative and not restrictive.

1. A fibre reinforced rock dowel for use in reinforcing strata or the like having a generally cylindrical shank having a longitudinal axis, the dowel defining a threaded end for the attachment of a nut having a left or right hand thread thereto wherein the dowel is reinforced by at least inner and outer filaments extending generally along the longitudinal axis and wherein at least the outer filaments extend in a generally helical path through the dowel with outer filaments extending in a helical path in the opposite sense to the thread of the threaded end.

2. A fibre reinforced rock dowel as claimed in claim 1 wherein one or more mixing vanes project from the shank.

3. A fibre reinforced rock dowel as claimed in claim 1 wherein the inner filaments include filaments located at or adjacent the centre of the dowel and which extend through the dowel in a generally straight line.

4. A fibre reinforced rock dowel as claimed in claim 3 wherein the outer filaments are longer than the innermost filaments.

5. A fibre reinforced rock dowel as claimed in claim 1 wherein both the inner and outer filaments are generally continuous through the length of the dowel.

6. A fibre reinforced rock dowel as claimed in claim 1 wherein the rock dowel is manufactured from reinforced plastic in a single moulding operation, the plastic is a thermoset and the reinforcing is a substantially continuous glass fibre.

7. A fibre reinforced rock dowel as claimed in claim 1 wherein the threaded end has a right hand thread and the outer filaments define a left handed helical path.

8. A fibre reinforced rock dowel as claimed in claims 1 wherein the threaded end has a left hand thread and the outer filaments define a right handed helical path.

9. A fibre reinforced rock dowel as claimed in claims 1 wherein the outer filaments define from 3 to 8 turns per metre of dowel.

10. A fibre reinforced rock dowel as claimed in claim 9 wherein the outer filaments define from 4 to 6 turns per metre of dowel.

11. A fibre reinforced rock dowel as claimed claim 1 wherein the outermost layers are oriented at an angle to the longitudinal axis of the dowel of from 5 to 20 degrees.

12. A method of manufacturing a fibre-reinforced rock dowel for use in reinforcing strata or the like, the dowel having a generally cylindrical shank defining a longitudinal axis, the dowel further defining a threaded end for the attachment of a nut comprising the steps of:
drawing a plurality of longitudinally extending resin coated reinforcing filaments including inner and outer filaments into an open mould;
rotating the filaments so that at least the outer filaments are oriented in a generally helical path;
closing the mould to form the dowel wherein the dowel is reinforced by inner and outer filaments extending generally along the longitudinal axis, wherein at least the outer filaments extend in a generally helical path through the dowel, and wherein the threaded end has a left or right handed thread and the generally helical path of the outer filaments is oriented in the opposite sense to the thread of the threaded end.

13. A method of manufacturing a fibre-reinforced rock dowel as claimed in claim 12 wherein the step of rotating the filaments involves clamping cured rock dowel located outside the mould, the continuous filaments extending into the cured rock dowel and rotating the cured rock dowel thereby rotating the filaments in the mould.

14. A method of manufacturing a fibre-reinforced rock dowel as claimed in claim 13 wherein the cured rock dowel is rotated through about 3 to 8 turns per metre of dowel to be formed in the mould.

15. A method of manufacturing a fibre-reinforced rock dowel as claimed in claim 12 wherein the filaments are coated with resin in a resin bath prior to entering the mould.

16. A method of manufacturing a fibre-reinforced rock dowel as claimed in claim 12 including the step of creating one or more mixing vanes projecting from the shank during the moulding of the dowel.
